(19) United States
(12) Patent Application Publication
(10) Pub. No.: US 2005/0184508 A1
(43) Pub. Date: Aug. 25, 2005

(54) Blood-recipient identification device and method

(76) Inventors: Matthew Verden, Lake Zurich, IL (US); Joseph J. Dallapiazza, Rochester Hills, MI (US)

Correspondence Address: WILDMAN HARROLD ALLEN & DIXON, 225 WEST WACKER DRIVE, SUITE 2800, CHICAGO, IL, 60606, US

(21) Appl. No.: 10/887,595

(22) Filed: Jul. 9, 2004

Related U.S. Application Data
(60) Provisional application No. 60/486,045, filed on Jul. 10, 2003.

(51) Int. Cl. G09C 3/00

(52) U.S. Cl. 283/117

(57) ABSTRACT

A blood-recipient identification device takes the form of an elongated band sized and configured to be folded and unfolded. The band has a head region including a first area in which information can be directly imprinted when the band is folded. The band has a tail region that opposes the head region when the band is unfolded. The tail region includes a second area comprising an image material. When the band is folded, the first area of the head region is placed into direct overlaying registry with the second area of the tail region. Imprinting information in the first area when the band is folded creates an image of the information in the second area. The band carries an identification code on the head and tail regions in association with the information imprinted in the first and second areas.

### CROSS REFERENCE TO RELATED APPLICATION

This application claims the priority from the U.S. Provisional Application No. 60/486,045 filed Jul. 10, 2003.

### BACKGROUND OF THE INVENTION

1. Field of the Invention

The invention relates to devices and methods for identifying blood-recipients and the corresponding units of cross-matched blood.

2. Description of the Related Art

A known blood-recipient identification device is described U.S. Pat. No. 3,698,383, of Baucom, which is incorporated herein by reference. The current device is commercially sold under the trademark TYPENEX®.

The conventional identification device seen in FIG. 1, includes an identification band 10 and a fastener 12 for use in blood handling procedures. The band 10 includes a tail 24, which carries an array of peel-away, pressure sensitive labels 26. Each label 26 is imprinted with the same identification code 28. This unique code 28 is also imprinted one or more times on the opposite end of the band 10, near the fastener 12. The fastener 12 comprises a plastic, clam-shell clip.

In use (as FIGS. 2A to 2H illustrate), the name of the patient and any other suitable information, as desired, are written in a patient ID label area 16 of the band 10 (see FIG. 2A). The patient ID label area 16 comprises a peel-away top coat 18 (see FIG. 2B) overlying a layer of image paper 20. The image paper 20 is impregnated with chemical constituents that are capable of interacting to provide a distinct image as a result of pressure impact. In this way, an image of information written on the top coat 18 is directly transferred onto the image paper 20.

When the technician peels off the top coat 18 (as FIG. 2B shows), the information image imprinted on the image paper 20 in the label area 16 remains on the band 10 (as FIG. 2C shows). The peel-away top coat 18 is attached to a blood specimen collection tube 14 (as FIG. 2D shows). The top coat 18 carries a pressure sensitive adhesive for this purpose.

The technician then peels away a release liner 22 on the backside of the tail 24 of the band 10 (see FIG. 2E). The backside of the tail 24 underlying the release liner 22 also carries a pressure-sensitive adhesive, which permits the technician to attach the tail 24 to the collection tube 14 (as FIG. 2F shows). The array of peel-away labels 26 with the unique identification code 28 are now carried by the pilot tube 14.

As FIG. 2G shows, the band 10 is then fastened (using the fastener 12) in bracelet fashion around the wrist or the ankle of the patient. Upon fastening, the band 10 is torn along one side of the fastener 12 (see FIG. 2H), to release the remainder of the band 10, which remains attached to the collection tube 14. The identification code 28 remains with the patient. It also remains with the collection tube 14.

A sample of blood is collected in the tube 14 in conventional fashion. The blood sample within tube 14 is thereafter typed and cross-matched with blood from a donor. Cross-matching may be accomplished in the usual manner. Typically, the donor's blood will be stored for transfusion within a blood collection bag. When compatible blood from a donor is found through cross matching, one of the peel-away labels 26 on the tail 24 attached to the pilot tube 14 is removed and attached to the blood collection bag containing the donor's blood. It is generally the practice to set up multiple units of blood for each patient. Therefore, the peel-away labels 26 may be removed from the tail 24 and affixed to multiple individual blood bags.

Before administering a blood unit to the patient, the nurse or attendant at bed side or in the operating suite matches the identification code 28 on the patient's bracelet band to the identification code 28 on the label 26 on the blood bag containing the blood to be transfused. The blood is administered to the patient only upon correspondence of the identification code 28 on the blood bag and the identification code 28 contained on the bracelet of the patient.

### SUMMARY OF THE INVENTION

A blood-recipient identification device having an elongated band sized and configured for manipulation between a folded configuration and an unfolded configuration. The band having a first region including a first area in which information can be directly imprinted and a second area having an image material. The band is positionable in the folded configuration with the first area of the first region placed in overlying registry with the second area of the second region such that imprinting information in the first area creates an image of the information in the second area.

### BRIEF DESCRIPTION OF THE DRAWINGS

FIG. 1 is a perspective view of a prior art blood-recipient identification device.

FIGS. 2A to 2H are perspective views showing the use of the prior art device shown in FIG. 1.

FIG. 3 is a perspective view of a blood-recipient identification band that embodies features of the invention, the band being shown in a folded condition at the outset of use.

FIG. 4 is a perspective view of the blood recipient identification band shown in FIG. 3, the band being shown in an unfolded condition.

FIGS. 5A to 5G are perspective views showing the use of the blood-recipient identification band shown in FIGS. 3 and 4.

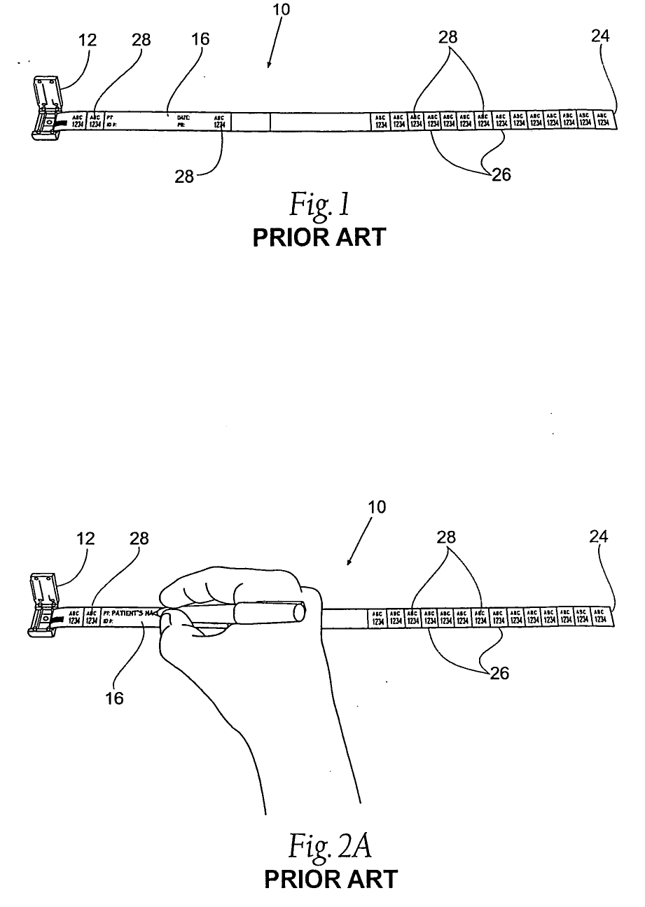

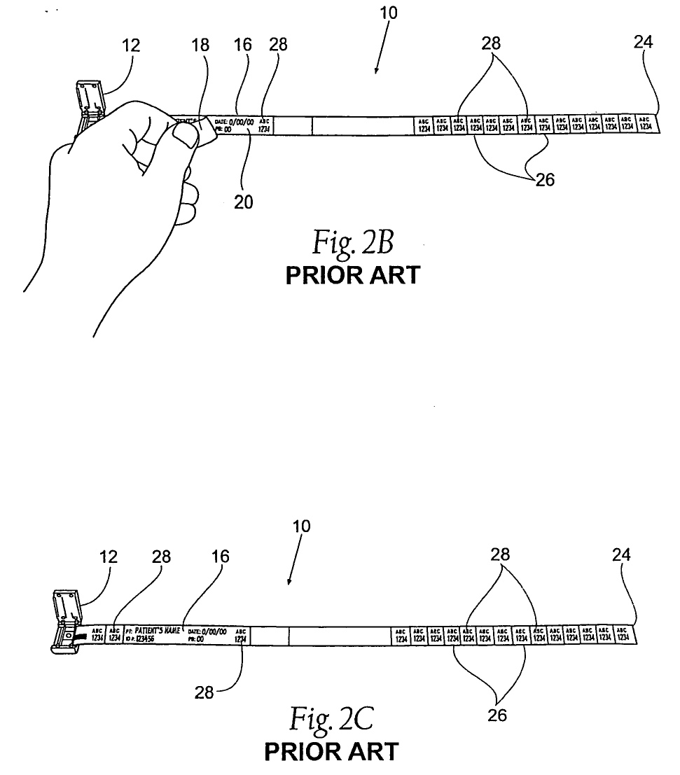

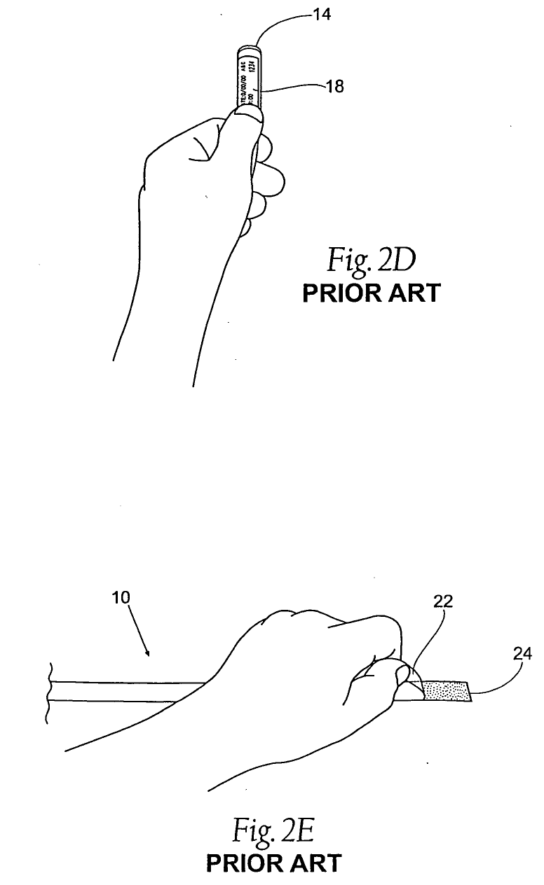

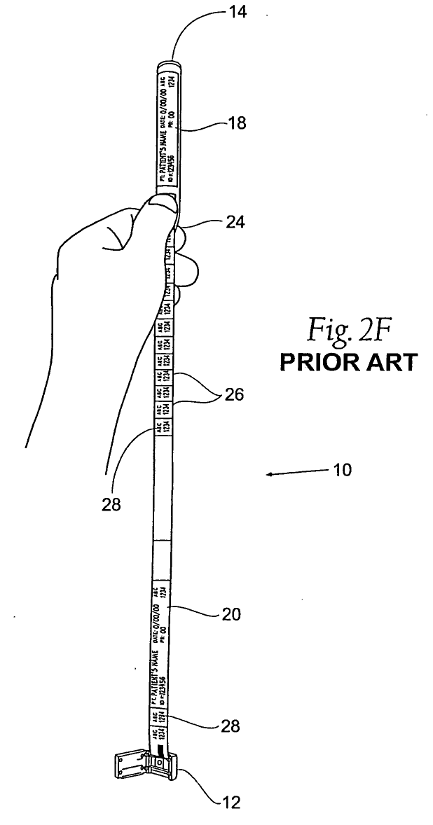

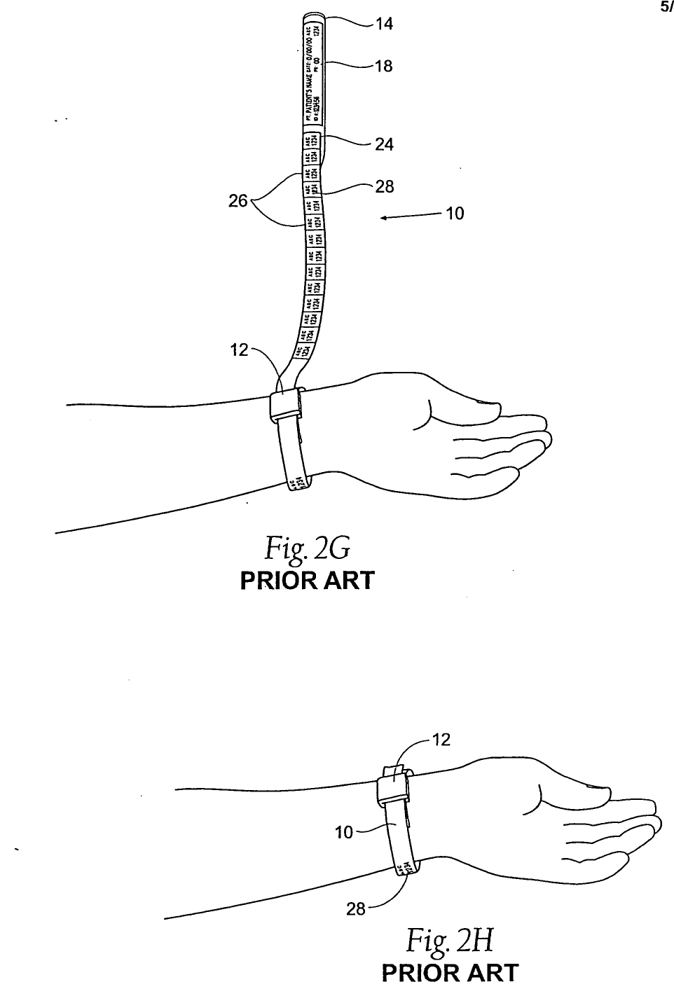

### DETAILED DESCRIPTION

While various embodiments have been described, the details may be changed without departing from the scope of the invention, which is defined by the claims. The physical embodiments herein disclosed merely exemplify the certain technical features, which may be embodied in other specific structure. Furthermore, since the embodiments described have particular utility in connection with blood handling and blood transfusion, the description that follows is specifically directed to this implementation. Nevertheless, it is to be understood that the discussion is not intended for the purpose of limitation but rather for the purpose of illustration. The technical features described herein have application in other related fields, as well.

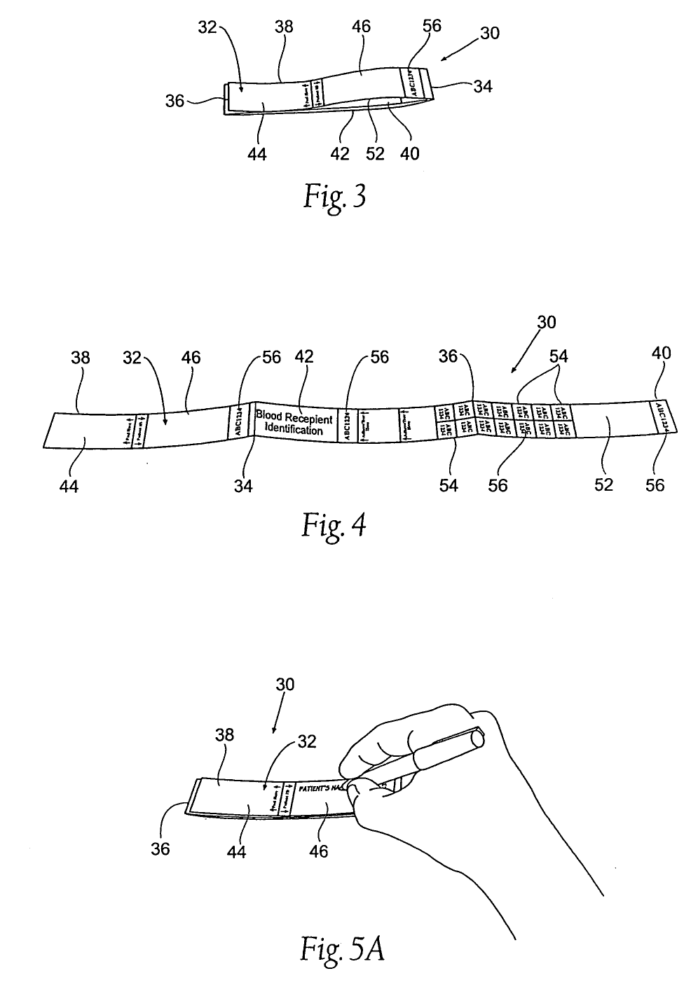

Referring to FIGS. 3 and 4, a blood-recipient identification device 30 shown. The device 30 includes a band 32. The band 32 is folded during manufacture into a compact configuration along two fold lines 34 and 36 (see FIG. 4).

The fold lines 34, 36 define three band regions (see FIG. 4)—a head region 38 to the left of the first fold line 34, a tail region 40 to the right of the second fold line 36, and a middle region 42 between the two fold lines 34 and 36. When folded for use, the band 32 is folded such that the head region 38 lays on top, the middle region 42 lays on the bottom—facing away from the head region 38, and the tail region 40 is sandwiched between the head region 38 and the middle region 42—facing toward the head region 38. In a representative embodiment, the band 32 presents a total length of about 16 inches and a width of about 1 inch. The fold lines 34 and 36 essentially trisect the band length.

The band 32 is desirably formed of a plastic film material which displays desirable use characteristics, such as tear strength and relative non-stretchability. These characteristics prevent removal of the band 32 from the wrist by ripping or stretching the band 32 over the hand or feet. Further, the material desirably displays the characteristic of sturdiness to support a blood specimen collection tube (as will be described later). The material is also somewhat rigid to maintain its band-like configuration while on the wrist or ankle, rather than roll up into a strand, while also being comfortable to wear. A band 32 formed of plastic (such as MYLAR-material, or thin film high impact polyethylene, polypropylene and vinyl) provides these characteristics.

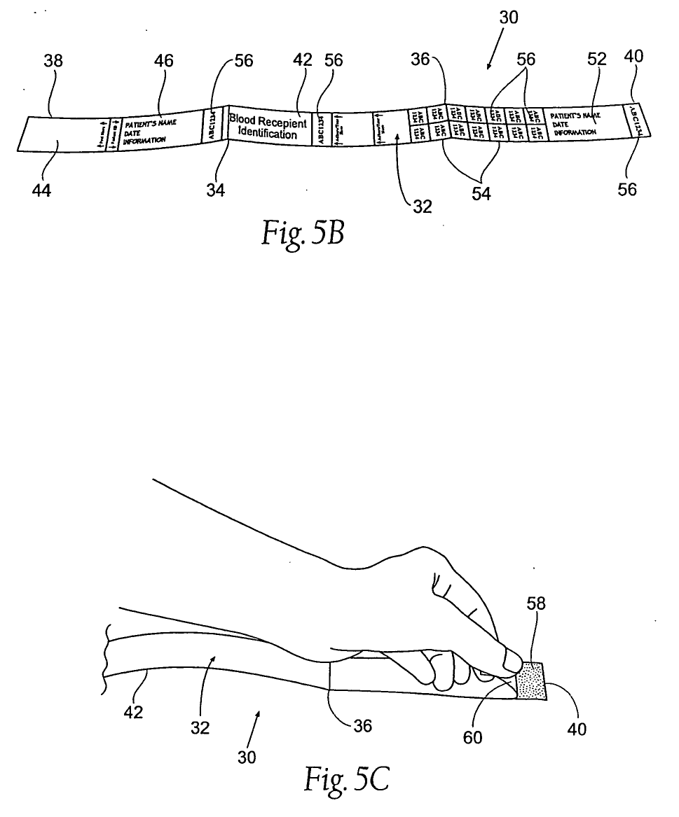

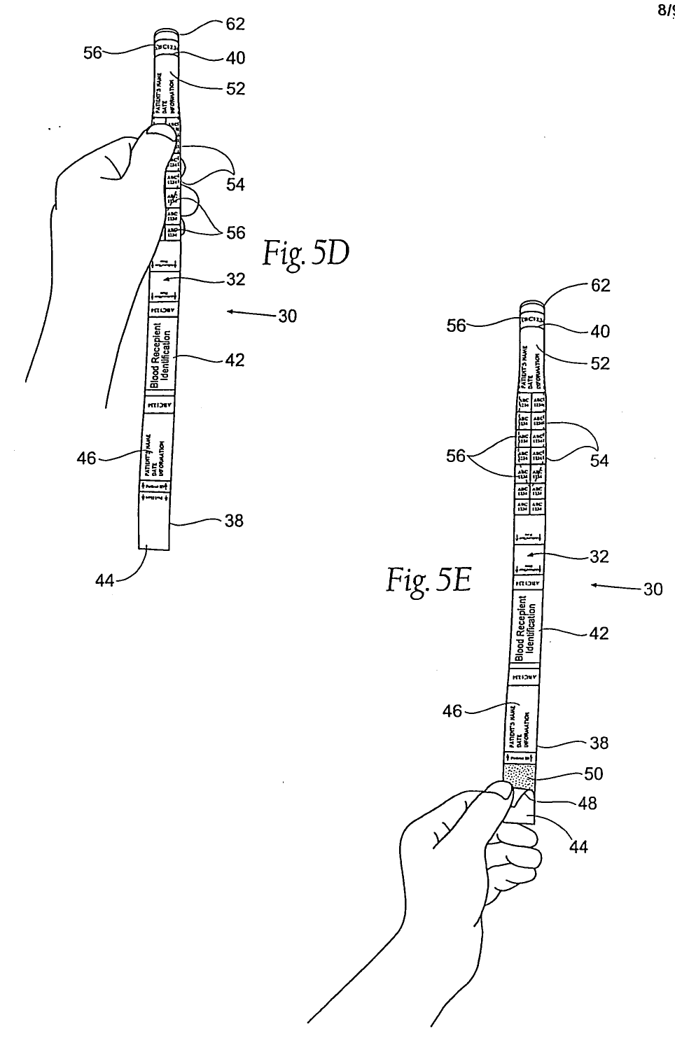

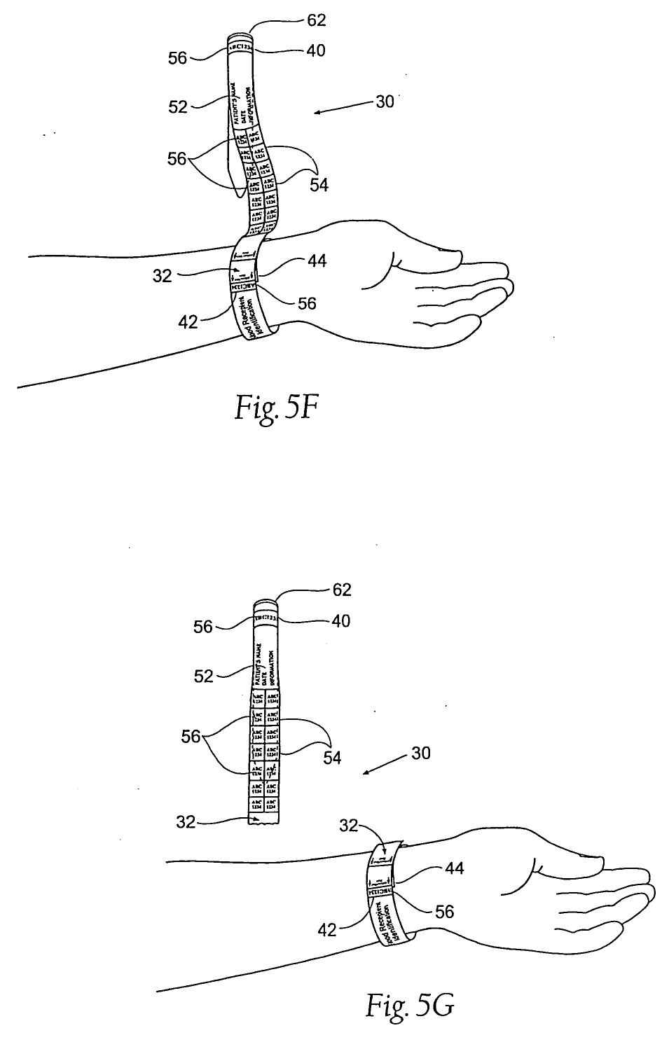

The head region 38 of the band 32 includes an outboard fastening area 44 and an inboard patient identification labeling area 46. The topside of the fastening area 44 carries a pressure-sensitive adhesive coating 50 (see FIG. 5E), which is covered before use by a tear away release liner 48 (see FIG. 5E).

The tail region 40 of the band 32 includes an outboard image paper area 52. When the band 32 is folded (as shown in FIG. 3), the outboard image paper area 52 of the tail 40 directly underlies and faces toward the backside of the inboard patient identification labeling area 46 of the head 38. Thus, when information is directly written or imprinted on the patient identification labeling region 46 of the head 38 (as shown in FIG. 5A), a true image of that information is directly transferred to the image paper area 52 of the tail 40 (as FIG. 5B shows).

The tail region 40 of the band 32 also includes (see FIG. 4), inboard of the image paper area 52, a region that carries an array of peel-away, pressure sensitive labels 54. Each label 54 carries the same identification code 56. In the illustrated embodiment (as shown in FIG. 4), the array of peel-away labels 54 can extend beyond the second fold line 36 into the middle region of the band 32. This arrangement makes it possible to increase the number of labels 54 carried by the band 32.

The unique identification code 56 is repeated elsewhere on the band 32. The head region 38 carries the identification code 56 inboard of the patient identification labeling area 46 next to the first fold line 34. The tail region 40 carries the identification code 56 outboard of the image paper area 52. The middle region 42 also carries the identification code 56.

At least a portion of the backside of the tail region 40 carries a pressure-sensitive adhesive coating 58 (see FIG. 5C), which is covered before use by a tear-away release liner 60 (also shown in FIG. 5C).

At the outset of use (see FIG. 5A), the band 32 is in its folded configuration (see FIG. 5A). When so folded, the name of the patient and any other suitable information, as desired, can be written directly in the patient identification labeling area 46 of the head region 38. This information can be directly handwritten onto the area 46 with a writing instrument, as FIG. 5A shows, or it can be directly impact-stamped onto the area 46 using, e.g., an ADDRESSOGRAPH™ Machine made by DataCard Corporation.

As before explained, when the band 32 is folded, an image of this information is simultaneously transposed directly onto the image paper area 52 of the underlying tail region 40. Therefore, upon unfolding the band 32 (as FIG. 5B shows), the identical patient information appears on both the head region 38 and the tail region 40. This information appears in association with the identification code 56 that these regions of the band 32 also carry.

After unfolding the band 32 (see FIG. 5C), the technician peels the release liner 60 from the back side of the tail region 40 to expose the pressure-sensitive adhesive coating 58. The tail region 40 of the band 32 can thereby be attached by the coating 58 to a blood specimen collection tube 62 (as FIG. 5D shows). The patient identification information appearing on the image paper area 52, along with the identification code 56, is now carried as an integrated part of the blood collection tube 62. The array of peel-away pressure sensitive labels 54, each also carrying the identification code 56 is now also carried by the collection tube 62.

The technician then peels away the release liner 48 on the topside of the head region 38, to expose the pressure-sensitive adhesive coating 50 (see FIG. 5E). As FIG. 5F shows, the band 12 is then looped in bracelet fashion around an extremity, e.g., the wrist or the ankle of the blood-recipient. The pressure-sensitive adhesive coating 50 on the head region 38 adheres to the backside of the middle region 42, to secure the band 32 to the wrist or ankle.

As FIG. 5G shows, the band 32 can be torn in the middle region 42 (clear of the labels 54) to release the tail region 40 of the band 32 from the head region 38. The tail region 40 remains attached to the blood collection tube 62, and the head region 38 remains with the blood-recipient.

A sample of blood from the blood-recipient is drawn into the tube 62 in conventional fashion, and is thereafter typed and cross-matched with blood from a donor, also in conventional fashion. As previously described, when compatible blood from a donor is found through cross-matching, the peel away labels 54 on the tail region 40 attached to the collection tube 62 are removed and attached to the blood collection bags containing the blood of the donor. As also previously described, before administering a blood unit to the blood-recipient, the nurse or attendant at bed side or in the operating suite matches the identification code 56 on the head (now bracelet) region 38 of the band 32 to the identification code 56 on the label 54 on the blood bag containing the blood to be transfused. The blood is administered to the blood-recipient only upon correspondence of identification code 56 on the blood bag and the identification code 56 on the bracelet of the blood recipient.

A method of using the blood-recipient identification device 30 is also provided. The elongated band 32 having area 46 in which information can be directly imprinted and a second area 52 having an image material is able to be moved between an unfolded configuration and a folded configuration. The band 32 is positioned in the folded configuration (See FIG. 5A) with the first area 46 placed in overlying registry with the second area 52. Information is imprinted in the first area 46 to create an image of the information is the second area 52. An identification code 56 is carried by the head region 38 and tail region 40 of the band 32 and is associated with the information imprinted in the first and second areas 46, 52.

The band 32 is unfolded and the tail region 40 of the band is affixed (FIG. 5D) to a blood sample collection tube 62. The head region 38 of the band 32 is secured in bracelet fashion around an extremity of the blood-recipient (See FIG. 5G). The tail region 40 of the band 32 is separated from the head region 38 whereby the tail region 40 remains affixed to the blood sample collection tube 62 and the head region 38 remains secured to the blood-recipient. Blood is then collected in the blood sample collection tube 62. The blood in the collection tube 62 is cross-matched with the donor blood and the identification code 56 is also associated with the cross-matched donor blood.

As described above, the blood-recipient identification device 30 has an elongated band 32 that is sized and configured to be folded at the outset of use and unfolded during the course of use. The band 32 has a head region 38 that includes a first area 46 in which information pertaining to the name, age, social security number etc. of the patient can be directly imprinted. The band 32 also has a tail region 40. The tail region 40 includes a second area 52 comprising an image material, which provides an image as a result of pressure impact. When the band 32 is unfolded, the tail region 40 opposes the head region 38. However, when the band 32 is folded, the first area 46 of the head region 38 is placed in overlaying registry with the second area 52 of the tail region 40. Thus, imprinting information directly in the first area 46 creates a true image of the information in the second area 52. Thus, when the band 32 is unfolded for further use, the imprinted information is found on both the head and tail regions. Both the head and tail regions 38, 40 also carry an identification code 56 in association with the information contained in the first and second areas 46, 52.

During use, the head region 38 and the information it carries are ultimately intended to be placed in bracelet fashion around a wrist or ankle of the blood recipient. During use, the tail region 40 and the matching information it carries are ultimately intended to be affixed to a blood sample collection tube 62. Since an image of the information imprinted in the first area 40 of the head region 38 is simultaneously formed in the second area 52 of the tail region 40, the need for a tear-away label for the blood collection tube, and the added step of applying this label, are eliminated. Furthermore, it is the information that is directly imprinted on the first area 46 that remains with the blood-recipient, and not the image of the information on image paper. The directly imprinted information is less likely to be smudged or to be wiped away by wear and exposure to moisture.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A blood-recipient identification device comprising an elongated band sized and configured for manipulation between a folded configuration and an unfolded configuration, the band having a first region including a first area in which information can be directly imprinted, and a second region including a second area comprising an image material, the band positionable in the folded configuration with the first area of the first region placed in overlying registry with the second area of the second region, such that imprinting information in the first area creates an image of the information in the second area.

2. The device of claim 1, wherein the first region is a head region of the elongated band and the second region is a tail region of the elongated band.

3. The device of claim 2, wherein the elongated band includes an identification code carried by the head and tail regions.

4. The device of claim 3, wherein the identification code carried by the head and tail regions is associated with the information imprinted in the first and second areas.

5. The device of claim 3, wherein at least a portion of the tail region includes a pressure-sensitive coating to adhere the tail region to a blood sample collection tube.

6. The device of claim 3, wherein at least a portion of the head region includes a pressure-sensitive coating to secure the band, when in the unfolded configuration, in bracelet fashion around an extremity of a blood-recipient.

7. The device of claim 3, wherein the band includes a middle region between the head and tail regions, the middle region being sized and configured to be torn to separate the head region from the tail region.

8. The device of claim 3, wherein the tail region carries an array of removable labels bearing the identification code.

9. The device of claim 8, wherein at least a portion of the tail region includes a pressure-sensitive coating to adhere the tail region to a blood sample collection tube, the band having a middle region between the head and tail regions, the middle region being configured to be torn to separate the head region from the tail region, and at least a portion of the head region having another pressure-sensitive coating to secure the band, when in the unfolded configuration, in bracelet fashion around an extremity of a blood-recipient.

10. The device of claim 9, wherein the band has a pair of fold lines which define the head region, middle region and tail region, in which the band in the folded configuration has the head region positioned to lay on top, the middle region lays on the bottom, and the tail region is sandwiched between the head region and the middle region.

11. The device of claim 9, wherein the first area is a patient identification labeling area and the second area is an image paper area, and in which the band, when in the folded configuration is positioned such that the image paper area of the tail region directly underlies and faces toward a backside of the patient identification labeling area of the head region.

12. The device of claim 9, wherein the head region, tail region and middle region each carry the identification code.

13. A method of using a blood-recipient identification device comprising:
moving an elongated band having a first area in which information can be directly imprinted and a second area having an image material between an unfolded configuration and a folded configuration;
positioning the band in the folded configuration with the first area placed in overlying registry with the second area; and
imprinting information in the first area to create an image of the information in the second area.

14. The method of claim 13 further comprising associating an identification code carried by head and tail regions of the band with the information imprinted in the first and second areas.

15. The method of claim 14 further comprising unfolding the band, and affixing the tail region of the band to a blood sample collection tube.

16. The method of claim 15 further comprising securing the head region of the band in bracelet fashion around an extremity of the blood-recipient, and
separating the tail region of the band from the head region of the band, whereby the tail region remains affixed to the blood sample collection tube and the head region remains secured to the blood-recipient.

17. The method of claim 16 further comprising collecting blood in the blood sample collection tube.

18. The method of claim 17 further comprising cross-matching the blood in the blood sample collection tube with donor blood, and
associating the identification code with the cross-matched donor blood.
